(19) United States
(12) Patent Application Publication
(10) Pub. No.: US 2014/0004497 A1
(43) Pub. Date: Jan. 2, 2014

(54) Method and System for Classroom Active Learning

(71) Applicant: ACTIVE LEARNING SOLUTIONS HOLDINGS LIMITED, Tortola (VG)

(72) Inventors: Hing Hoi Howard Wong, Hong Kong (HK); Kam Wo Kevin Mak, Hong Kong (HK)

(73) Assignee: ACTIVE LEARNING SOLUTIONS HOLDINGS LIMITED, Tortola (VG)

(21) Appl. No.: 13/685,720

(22) Filed: Nov. 27, 2012

Related U.S. Application Data
(60) Provisional application No. 61/684,156, filed on Aug. 17, 2012.

(30) Foreign Application Priority Data
Jun. 28, 2012 (CN) 201210214105.8

(51) Int. Cl. G09B 7/00

(52) U.S. Cl. CPC G09B 7/00
USPC 434/350

(57) ABSTRACT

A method and system for conducting interactive classroom learning that can utilize a plurality of electronic audio and video equipments, mobile computing devices, and processing servers, interconnected via a first network infrastructure in a classroom or presentation hall to deliver seamlessly interactive multimedia contents to each of one or more participants in classroom or presentation hall; wherein the participants comprises one or more lecturers or presenters, and one or more students or audiences. The method and system allow the control and coordination of the electronic audio and video equipments, mobile computing devices, and the processing servers to deliver the interactive multimedia contents to the participants in the classroom or presentation hall simultaneously and to facilitate the information input-output interactions to and from the participants; wherein the interactive multimedia contents can be divided into multiple parts or streams, and each being personalized for each or each subset of the participants.

### CLAIM FOR FOREIGN AND DOMESTIC PRIORITY

This application claims priority under 35 U.S.C. §119 to the China Patent for Invention Application No. 201210214105.8, filed Jun. 28, 2012, and the disclosure of which is incorporated herein by reference in its entirety. This application also claims priority under 35 U.S.C. §119 to the U.S. Provisional Utility Patent Application No. 61/684,156, filed Aug. 17, 2012, and the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to classroom information technology. Particularly, the present invention relates to methods and systems of classroom learning and presentation of lecture materials. More particularly, the present invention relates to the interactive classroom learning methods and systems using a network of coordinated electronic devices for presenting the lecture materials and facilitating the lecturer's and students' participation.

### BACKGROUND

Traditionally, the use of information technology in classrooms and presentation halls is limited to ad hoc fashions. Often it merely involves the display of presentation slides or videos using an overhead projector or large video display monitor and an integrated sound system. Better-equipped classrooms or presentation halls would provide wireless network infrastructures for Internet connection and intra-room networking capability for the participants to be interconnected using their own mobile computing devices. Still more advanced classrooms or presentation halls would allow interactive lecture or presentation material contents to be accessed by the connected mobile computing devices, complimenting the lecture or presentation in progress.

However, there has not been any system that can deliver a seamless interactive lecture or presentation experience to the participants through the use of a plurality of information technology equipment of various types. For instance, while most arrangements of information technology equipments are capable of simultaneously delivering non-interactive contents through an overhead projector, the sound system, and perhaps to the participants' individual mobile computing devices by video-streaming via wireless network; no existing system can deliver interactive contents comprising many different tracks to different equipments such that the content being displayed by the overhead projector can be different from the content being video-streamed to the participants' individual mobile computing devices, and yet the playback of each of the different track of interactive contents being real-time synchronized and controllable by the lecturer or presenter.

Another shortcoming of currently available systems is that the initial setup for delivering the lecture or presentation material contents to a range of different information technology equipments can be burdensome and time consuming, degrading the overall participants' experience of the lecture or presentation. For instance, the connection of each participant's mobile computing device to the classroom's or presentation hall's network infrastructure for content access can involve software and hardware network configurations, the device's and the participant's authentication and authorization. This process is prone to human errors and it must be carried out by each participant.

### SUMMARY

It is an objective of the presently claimed invention to provide a method and system for conducting interactive classroom learning that can utilize a plurality of electronic audio and video equipments, mobile computing devices, and processing servers, interconnected via a first network infrastructure in a classroom or presentation hall to deliver seamlessly interactive multimedia contents to each of one or more participants in classroom or presentation hall; wherein the participants comprises one or more lecturers or presenters, and one or more students or audiences.

It is a further objective of the presently claimed invention to provide the method and system that can control and coordinate the electronic audio and video equipments, mobile computing devices, and the processing servers to deliver the interactive multimedia contents to one or more of the participants in the classroom or presentation hall simultaneously and to facilitate the information input-output interactions to and from the participants; wherein the interactive multimedia contents can be divided into multiple parts or streams, and each being personalized for each or each subset of the participants.

It is still a further objective of the presently claimed invention to provide the method and system that allows rapid and highly automated participant authentication and network connectivity setup for new participants with their mobile computing devices joining the first network infrastructure in the classroom or presentation hall.

It is still a further objective of the presently claimed invention to provide the method and system that allows the first network infrastructure to facilitate the simultaneous streaming of multiple parts or streams of the interactive multimedia contents to the electronic audio and video equipments and mobile computing devices with a network latency of no more than 500 milliseconds, enabling a real-time synchronized interactive lecture or presentation experience among the plurality of participants in the classroom or presentation hall.

In accordance with various embodiments, the presently claimed invention comprises a first processing server for one or more classrooms or presentation halls; a mobile computing device for each of one or more participants in each of the classrooms or presentation halls, wherein the mobile computing devices can be tablet computers, laptop computers, Netbook computers, and/or combinations thereof; and optionally one or more electronic audio and video equipments in each of the classrooms or presentation halls, wherein the electronic audio and video equipments can be overhead projectors, electronic video displays, sound amplifying systems, and/or combinations thereof. In accordance with one embodiment, the first processing server, the mobile computing devices, and the electronic audio and video equipments are interconnected via the first network infrastructure, wherein the first network infrastructure can be a local area wired, wireless, or a combination of wired and wireless network. In the case of local area wired network, the first network infrastructure includes a router; and in the case of local area wireless network, the first network infrastructure includes a network access point.

In accordance with various embodiments, the first processing server is configured to exchange data with the mobile computing devices, wherein the data includes participants input and parts or streams of the interactive multimedia contents. The first processing server is also configured to allow participant control of the electronic audio and video equipments using one of the mobile computing devices and feed parts or streams of the interactive multimedia contents to the electronic audio and video equipments. The first processing server is also configured to control the first network infrastructure via the network access point or router, adjust and/or segment its connectivity coverage area, enable and disable network connections of and networked resource accesses by the mobile computing devices. In accordance with one embodiment, the first processing server also comprises a data repository for storage of participant information, the interactive multimedia contents, and lecture or presentation materials. In accordance with another embodiment, the first processing server communicates with a second processing server for data retrieval and storage via a second network infrastructure, wherein the second process server comprises a data repository for storage of participant information, the interactive multimedia contents, and lecture or presentation materials.

In accordance with various embodiments, the mobile computing devices are grouped into at least two groups: a lecturer or presenter group, and a student or audience group. Mobile computing devices in the lecturer or presenter group are configured to interact with the first processing server to achieve the following functions:
1. Control and monitor the functions and status, including power on/off, sleep mode on/off, volume, and general conditions, of the electronic audio and video equipments;
2. Control and monitor the display, speaker, other functions and status, including power on/off, sleep mode on/off, interactive multimedia contents playback, access authorization to data in the first processing server, network resource access, network connectivity, volume, storage capacity, battery level, and general device conditions, of each of the mobile computing devices in the student or audience group;
3. Control and monitor the functions and status of the first network infrastructure, including connectivity coverage area segmentation, network connections and networked resource access authorization for the mobile computing devices; and
4. Control the delivery of the interactive multimedia contents and lecture or presentation materials to each or subset of the electronic audio and video equipments and each or subset of mobile computing devices, wherein the parts or streams of the interactive multimedia contents and lecture or presentation materials can be different for each or subset of the electronic audio and video equipments and each or subset of mobile computing devices according to a pre-configured setting for the particular interactive multimedia contents or participant control input from the mobile computing devices in the lecturer or presenter group.

In accordance with various embodiments, each of the mobile computing devices in the lecturer or presenter group are configured to allow communication with each of the mobile computing devices in the student or audience group, wherein the communication can be text and/or graphical based. In accordance with various embodiments, each of the mobile computing devices is configured to be able to access the first processing server for viewing the lecture or presentation materials. In addition, each of the mobile computing devices is configured to receive participant's answers to materials displayed that require user input from the participant. The participant's input data is then sent to the first processing server for storage and can be viewed from the other mobile computing devices.

### BRIEF DESCRIPTION OF THE DRAWINGS

Embodiments of the invention are described in more detail hereinafter with reference to the drawings, in which

FIG. 1 shows a block diagram illustrating an exemplary embodiment of the presently claimed classroom interactive learning system;

FIG. 2 shows a flow diagram of a device registration process in accordance to an embodiment of the presently claimed classroom interactive learning system; and

FIG. 3a and FIG. 3b show the flow diagrams of a participant authentication process in accordance to an embodiment of the presently claimed classroom interactive learning system.

### DETAILED DESCRIPTION

In the following description, methods and systems of classroom interactive learning and presentation hall interactive presentation and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

System:

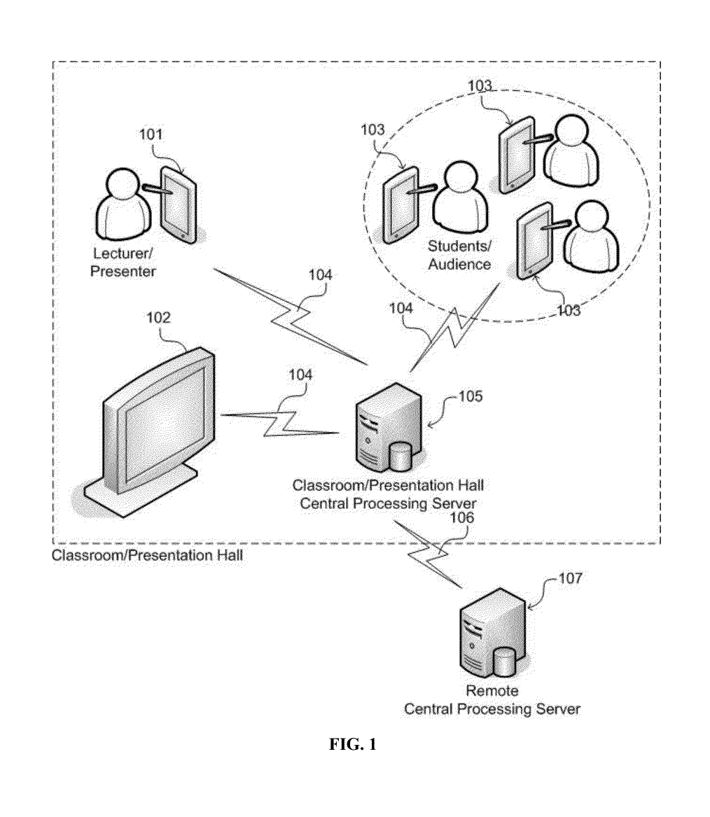

Referring to FIG. 1. In accordance with various embodiments the presently claimed invention comprises a first processing server 105 for one or more classrooms or presentation halls; a specifically configured mobile computing device for each of participants in each of the classrooms or presentation halls (101 and 103); and optionally one or more network-capable electronic audio and video equipments 102 in each of the classrooms or presentation halls, wherein the electronic audio and video equipments can be overhead projectors, electronic video displays, sound amplifying systems, and/or combinations thereof In accordance with one embodiment, the first processing server 105, the mobile computing devices 101 and 103, and the electronic audio and video equipments 102 are interconnected via a first network infrastructure 104, forming an active learning solution (ALS) infrastructure for the classroom or presentation hall. The first network infrastructure 102 can be a local area wired, wireless, or a combination of wired and wireless network supporting the TCP/IP protocol. In the case of local area wired network, the first network infrastructure 102 includes a router; and in the case of local area wireless network, the first network can be based on Wi-Fi technology according to the various IEEE 802.11 standards and includes a network access point. The first network also includes network components providing anti-intrusion and access control functionalities.

In accordance with various embodiments, the first processing server 105 is configured to exchange data with the mobile computing devices 101 and 103, wherein the data includes user inputs and parts or streams of the interactive multimedia contents. The first processing server 105 is also configured to allow participant control of the electronic audio and video equipments 102 using one of the mobile computing devices and feed parts or streams of the interactive multimedia contents to the electronic audio and video equipments. The first processing server 105 is also configured to control the first network infrastructure via the network access point or router, adjusting and/or segmenting its connectivity coverage area, enabling and disabling network connections and networked resource accesses of the mobile computing devices. In accordance with one embodiment, the first processing server 105 also comprises a data repository for storage of participant information, the interactive multimedia contents, and other lecture or presentation materials. In accordance with another embodiment, the first processing server 105 communicates with a second processing server 107 for data retrieval and storage via a second network infrastructure 106, wherein the second processing server 107 comprises a data repository for storage of participant information, the interactive multimedia contents, and other lecture or presentation materials. The second network infrastructure 106 can be the first network infrastructure 104; a separate local area wired, wireless, or a combination of wired and wireless network supporting the TCP/IP protocol; a wide area communication network or a telecommunication network supporting the Internet protocols.

In accordance with various embodiments, the mobile computing devices 101 and 103 are grouped into at least two groups: a lecturer or presenter group, and a student or audience group. Mobile computing devices in the lecturer or presenter group (101) are configured to interact with the first processing server 105 to achieve the following functions:
1. Control and monitor the status, including power on/off, battery level, network connectivity, volume, and general conditions, of the electronic audio and video equipments;
2. Control and monitor the display, sound volume, power on/off, sleep mode on/off, interactive multimedia contents playback, access authorization to data in the first processing server, network resource access, network connectivity, storage capacity, battery level, and general device conditions, of each of the mobile computing devices in the student or audience group;
3. Control and monitor the first network, adjusting and/or segmenting its connectivity coverage area, enabling and disabling network connections and networked resource accesses of each or subset of the mobile computing devices; and
4. Control the delivery of the interactive multimedia contents to each or subset of the electronic audio and video equipments and each or subset of the mobile computing devices, wherein the parts or streams of the interactive multimedia contents can be different for each or subset of the electronic audio and video equipments and each or subset of the mobile computing devices according to a pre-configured setting for the particular interactive multimedia contents or participant control input from the mobile computing devices in the lecturer or presenter group.

In accordance with various embodiments, each of the mobile computing devices in the lecturer or presenter group (101) are configured to allow communication with each of the mobile computing devices in the student or audience group (103), wherein the communication can be textual and/or graphical. In accordance with various embodiments, each of the mobile computing devices 101 and 103 is configured to be able to access the first processing server 105 for viewing lecture or presentation and other reference materials. In addition, each of the mobile computing devices 101 and 103 is configured to receive participant's answers to materials displayed that require user input from the participant. The participant's input data is then sent to the first processing server 105 for storage and can be viewed from the other mobile computing devices 101 and 103.

In accordance to exemplary embodiments of the processing servers 105 and 107, the configuration of the processing servers 105 and 107 can be achieved by the installation and execution of specially designed server application software, which includes at least a user interface and server backend machine instruction codes.

Exemplary embodiments of the mobile computing devices 101 and 103 include tablet computers, laptop computers, and netbook computers that are wireless-networking enabled. The configuration of the mobile computing device 101 and 103 can be achieved by the installation and execution of specially designed application software, which includes at least a user interface and machine instruction codes. One exemplary embodiment of such application software installed in and executed by a tablet computer is a mobile application (App) running on the iOS operating system developed by Apple Inc. Another exemplary embodiment of such user interface is a mobile application (App) running on the Android operating system developed by Google Inc. In addition, various exemplary embodiments of the mobile computing devices include electronic components and circuitries for image capturing and near field communication (NFC). A NFC-enabled mobile computing device can retrieve data from a NFC-enabled device such as a NFC-enabled data storage or security access card.

Registering a New Mobile Computing Device in the ALS Infrastructure of the Classroom or Presentation Hall:

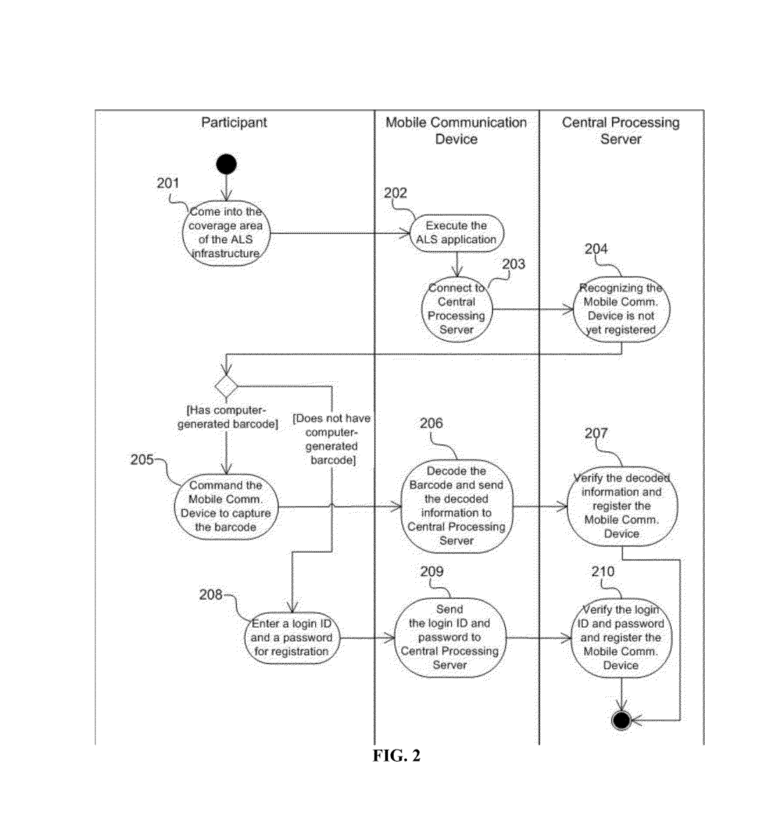

Referring to FIG. 2. A mobile computing device that has not previously been registered with a particular ALS infrastructure of a classroom or presentation hall must first be registered with the ALS infrastructure before joining it.

The registration of a mobile computing device with an ALS infrastructure comprises: 201.) the mobile computing device entering the coverage area of the ALS infrastructure; 202.) launching and executing an ALS application in the mobile computing device; 203.) the mobile computing device connecting to the ALS infrastructure; 204.) a first processing server in the ALS infrastructure recognizing the mobile computing device is not yet registered and instructing the mobile computing device to prompt its user for registration; 205.) if the user of the mobile computing device has a computer-generated barcode, the user can command the mobile computing device to perform an image capture of the computer-generated barcode, wherein the computer-generated barcode can be a matrix or two-dimensional barcode such as a Quick Response (QR) code, and wherein the computer-generated barcode contains encoded information on the identity of the participant and the mobile computing device; 206.) the mobile computing device decoding the computer-generated barcode and sending the decoded information of the computer-generated barcode to the first processing server for verification; 207.) upon a positive verification, the mobile computing device is registered; 208.) if the user of the mobile computing device does not have a computer-generated barcode, the user can enter a login ID and a password for registration in a user interface of the ALS application running in the mobile computing device; 209.) the mobile computing device sending the login ID and password to first processing server for verification; 210.) upon a positive verification, the mobile computing device is registered.

Connecting a Mobile Computing Device to the ALS Infrastructure of the Classroom or Presentation Hall:

In order to access the networked resources, participate in an interactive lecture or presentation session, and view the interactive multimedia contents of an ALS infrastructure of a classroom or presentation hall, a participant must first authenticate and have his/her registered mobile computing device join the ALS infrastructure. In accordance to various embodiments, participants are divided into two groups: lecturer or presenter group and student or audience group. The processes of participant authentication and joining of a mobile computing device to an ALS infrastructure are different for these two groups of participants.

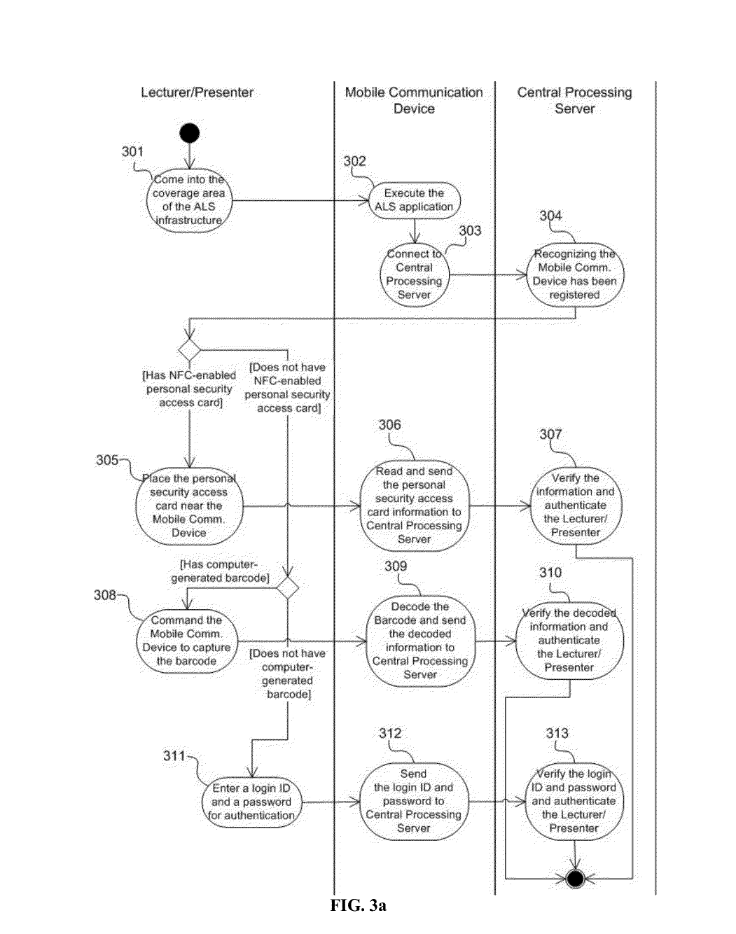

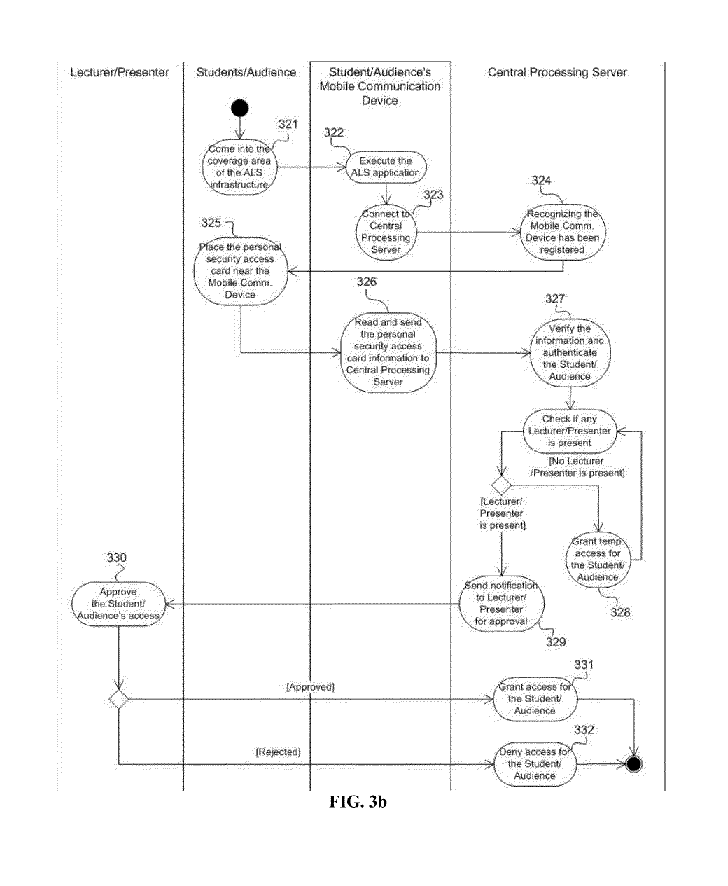

Referring to FIG. 3a. The participant authentication and joining of a mobile computing device to an ALS infrastructure for a participant in the lecturer or presenter group comprises: 301.) the mobile computing device entering the coverage area of the ALS infrastructure; 302.) launching and executing the ALS application in the mobile computing device; 303.) the mobile computing device connecting to the ALS infrastructure; 304.) a first processing server in the ALS infrastructure recognizing the mobile computing device has been registered and instructing the mobile computing device to prompt its participant for authentication; 305.) if the participant of the mobile computing device has a NFC-enabled personal security access card, the participant can motion the personal security access card near the mobile computing device for the mobile computing device to retrieve the participant's personal security access information from the personal security access card; 306.) the mobile computing device sending the participant's personal security access information to the first processing server for authentication; 307.) upon a positive authentication, the mobile computing device joins the ALS infrastructure; 308.) if the participant of the mobile computing device has a computer-generated barcode, the participant can command the mobile computing device to perform an image capture of the computer-generated barcode, wherein the computer-generated barcode can be a matrix or two-dimensional barcode such as a Quick Response (QR) code and wherein the computer-generated barcode contains encoded information on the identity of the participant and the mobile computing device; 309.) the mobile computing device decoding the computer-generated barcode and sending the decoded information of the computer-generated barcode to the first processing server for authentication; 310.) upon a positive authentication, the mobile computing device joins the ALS infrastructure; 311.) if the participant of the mobile computing device does not have a NFC-enabled security access card or a computer-generated barcode, the participant can enter a login ID and a password for authentication in the ALS application user interface running in the mobile computing device; 312.) the mobile computing device sending the login ID and password to first processing server for authentication; 313.) upon a positive authentication, the mobile computing device joins the ALS infrastructure.

Referring to FIG. 3b. The participant authentication and joining of a mobile computing device to an ALS infrastructure for a participant in the student or audience group comprises: 321.) the mobile computing device coming into the coverage area of the ALS infrastructure; 322.) launching and executing the ALS application in the mobile computing device; 323.) the mobile computing device running the ALS application connecting to the ALS infrastructure; 324.) a first processing server in the ALS infrastructure recognizing the mobile computing device has been registered and instructing the mobile computing device to prompt its participant for authentication; 325.) the participant places his/her NFC-enabled personal security access card near the mobile computing device for retrieving the participant's personal security access information from the personal security access card; 326.) the mobile computing device sending the participant's personal security access information to the first processing server for authentication; 327.) upon a positive authentication, if no participant from a lecturer or presenter group has joint the ALS infrastructure, 328.) the mobile computing device joins the ALS infrastructure on a temporary basis, when participant from the lecturer or presenter group joins the ALS infrastructure, 329.) the first processing sends a notification to his/her mobile computing device requesting his/her approval of the mobile computing device of the participant from the student or audience group joining the ALS infrastructure; if at least one participant from a lecturer or presenter group has joint the ALS infrastructure, 329.) a notification is sent to the mobile computing device of the participant from the lecturer or presenter group requesting the participant from a lecturer or presenter group to approve of the mobile computing device of the participant from the student or audience group joining the ALS infrastructure. If the participant from the lecturer or presenter group rejects the request, 332.) the mobile computing device of the participant from the student or audience group is refused from participation in the interactive lecture or presentation session in the ALS infrastructure and denied access to any networked resource in the ALS infrastructure; otherwise 331.) the mobile computing device joins the ALS infrastructure.

Classroom or Presentation Hall Management:

In accordance to one embodiment of the presently claimed invention, participants in an ALS infrastructure of a classroom or presentation hall are divided into two groups: lecturer or presenter group and student or audience group. Through a ALS application user interface running in the mobile computing device, a participant from the lecturer or presenter group can control and monitor individually and collectively the mobile computing devices of the participants from the student or audience group. Status of the mobile computing devices that can be monitored include: sleep mode on/off, battery level, volume, download progress of interactive multimedia contents and lecture or presentation materials, contents being displayed on the mobile computing devices, and whether the mobile computing devices are locked/unlocked from participant operation. Functions of the mobile computing devices that can be controlled include: sleep mode on/off, volume, lock/unlock from participant operation, download and playback of interactive multimedia contents and lecture or presentation materials, sharing of the contents being displayed on any mobile computing device with any other mobile computing device and/or any of the electronic audio and video equipments.

Exemplary Interactive Multimedia Contents and Their Playback in the Classroom or Presentation Hall:

1.) Literature Composition:

A participant in the lecturer or presenter group, by commanding through and providing user input to the ALS application user interface running in his/her mobile computing device, can create sub-groups of participants for the student or audience group for a group participation or competition in a lecture session on literature composition. The participant in the lecturer or presenter group can select the members for each sub-group and optionally a leader for each sub-group. Parts or streams of an interactive multimedia contents are fed to the mobile computing devices of the participants in the student or audience group. Each sub-group can receive the same or different parts or streams of the interactive multimedia contents. This can be controlled and monitored by the participant in the lecturer or presenter group through the ALS application user interface running in his/her mobile computing device. The ALS application user interface running in the mobile computing device of each participant in each sub-group in the student or audience group displays the respective parts or streams of the interactive multimedia contents and provides a text input area for the participant to enter his/her text composition related to or inspired by the respective parts or streams of the interactive multimedia contents. Each participant's text composition is shown simultaneously in the ALS application user interface running in the mobile computing devices of other participants in the sub-group. The final text composition is resulted from combining the individual text compositions of each participant in the sub-group. The final text compositions from each sub-group are then sent to the mobile computing device of the participant in the lecturer or presenter group for review. The participant in the lecturer or presenter group can choose to display all final text compositions in all of the mobile computing devices and/or in one or more of the electronic video and audio equipments, such as an overhead projector, by commanding through the ALS application user interface running in the mobile computing device of the participant in the lecturer or presenter group.

2.) In Session Questions and Answers:

The interactive multimedia contents can include one or more video clips, images, sound bits, and/or combination thereof; accompanied by a series of questions and possible answers. A participant in the lecturer or presenter group, by commanding through and providing user input to the ALS application user interface running in his/her mobile computing device, starts a video clips, images, and/or sound bits download and playback in all of mobile computing devices of participants in the student or audience group for a question-and-answer session. The corresponding questions are being displayed along side with the video clips, images, and/or sound bits. The questions shown can be multiple-choice questions with their corresponding selections of possible answers. The participant in the lecturer or presenter group can control the pace of the playback of the video clips, images, and/or sound bits, and lengths of time for answering the questions. Each student or audience enters his/her answer to each question in the ALS application user interface running in his/her mobile computing device. The answers from each student or audience are sent to the mobile computing device of the participant in the lecturer or presenter group for review. After the questions and answers session is concluded, statistics relating to the performance of the students or audiences, such as the percentage of corrected answers for each question, the number of corrected answers for each student or audience, answering time for each question and for each student or audience, and the number of student or audience who made certain answer selections on each question, are computed and made available for review in all of the mobile computing devices and/or one or more of the electronic video and audio equipments, such as an overhead projector, by commanding through the ALS application user interface running in the mobile computing device of the participant in the lecturer or presenter group.

3.) E-Textbook Playback:

The interactive multimedia contents can include one or more interactive video clips, images, text, and/or combination thereof in the format of a textbook having multiple sections and/or chapters. A participant in the lecturer or presenter group, by commanding through and providing user input to the ALS application user interface running in his/her mobile computing device, starts the interactive multimedia contents download and playback in all of mobile computing devices of participants in the student or audience group and/or one or more of the electronic video and audio equipments, such as an overhead projector. The participant in the lecturer or presenter group can select and control the pace of the playback of the sections and/or chapters in the mobile computing device of each student or audience. Alternatively, the participant in the lecturer or presenter group can also surrender all or part of the selection and control of the playback of the sections and/or chapters to the students or audiences.

4.) Voting:

The interactive multimedia contents can include one or more interactive video clips, images, text, and/or combination thereof in the format of a series of sets of selectable items. A participant in the lecturer or presenter group, by commanding through and providing user input to the ALS application user interface running in his/her mobile computing device, starts the interactive multimedia contents download and playback in all of mobile computing devices of the participants in the student or audience group and/or one or more of the electronic video and audio equipments, such as an overhead projector. The participant in the lecturer or presenter group can select and control the pace of the playback of the sets of selectable items in the mobile computing device of each student or audience. Alternatively, the participant in the lecturer or presenter group can also surrender all or part of the selection and control of the playback of the sets of selectable items to the students or audiences. Each student or audience casts his/her vote on the selectable items in each set of selectable items in the ALS application user interface running in his/her mobile computing device. After the voting session is concluded, statistics of the overall vote of the students or audiences on each set of selectable items are computed and made available for review in all of the mobile computing devices and/or one or more of the electronic video and audio equipments, such as an overhead projector, by commanding through the ALS application user interface running in the mobile computing device of the participant in the lecturer or presenter group.

The embodiments disclosed herein may be implemented using general purpose or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for conducting interactive learning session in a classroom or presentation in a presentation hall, comprising:
a first network infrastructure;
a first processing server connected to the first network infrastructure and configured to serve multimedia lecture or presentation material content data and exchange data from one or more mobile computing devices connected to the first network infrastructure;
the one or more mobile computing devices for receiving and displaying the multimedia lecture or presentation material content data, facilitating user input, and receiving the input data, comprising at least one mobile computing device adapted to be used by lecturer or presenter and one or more mobile computing devices adapted to be used by students or audience;
wherein the first processing server and the one or more mobile computing devices are interconnected via a first network infrastructure;
wherein the lecturer or presenter, by using the mobile computing device adapted to be used by lecturer or presenter, controls and monitors display, sound volume, power on/off, sleep mode on/off, interactive multimedia contents playback, access authorization to data in the first processing server, network resource access, network connectivity, volume, storage capacity, battery level, and general device conditions;
wherein the lecturer or presenter, by using the mobile computing device adapted to be used by lecturer or presenter, controls and monitors the first network infrastructure, adjusting and/segmenting its connectivity coverage area, enabling and disabling network connections and networked resource accesses of each or subset the mobile computing devices; and
wherein the lecturer or presenter, by using the mobile computing device adapted to be used by lecturer or presenter, controls delivery of the multimedia lecture or presentation material content data to each or subset of mobile computing devices, wherein the multimedia lecture or presentation material content data comprises one or more different parts each being delivered to each or subset of mobile computing devices according to a pre-configured setting for the multimedia lecture or presentation material content data or user input from the mobile computing device adapted to be used by lecturer or presenter.

2. The system of claim 1, further comprising:
one or more electronic audio and video equipments for receiving and displaying the multimedia lecture or presentation material content data;
wherein the lecturer or presenter, through the mobile computing device adapted to be used by lecturer or presenter, can control delivery of the multimedia lecture or presentation material content data to each or subset of audio and video equipments, wherein the multimedia lecture or presentation material content data comprises one or more different parts each being delivered to each or subset of audio and video equipments according to a pre-configured setting for the multimedia lecture or presentation material content data or user input from the mobile computing device adapted to be used by lecturer or presenter.

3. The system of claim 1, further comprising:
a second network infrastructure; and
a second processing server connected to the second network infrastructure and configured to store the multimedia lecture or presentation material content data to be retrieved by the first processing server also connected to the second network infrastructure.

4. The system of claim 1, wherein the one or more mobile computing devices performing a device registration process before connecting to the first network infrastructure, the device registration process comprising:
one of the one or more mobile computing devices attempting to connect to the first network infrastructure;
the first processing server determining whether the mobile computing device has been registered for connecting to the first network infrastructure; and
if the mobile computing device has not been registered, the device registration process further comprising:
the first processing server sending data to the mobile computing device instructing the mobile computing device to prompt the participant of the mobile computing device to register the mobile computing device with the first network infrastructure;
if the participant of the mobile computing device has a computer-generated barcode for device registration, the computer-generated barcode is optically captured and decoded by the mobile computing device, and decoded information of the computer-generated barcode is sent to the first processing server for verification;
else if the participant of the mobile computing device does not have a computer-generated barcode for device registration, the participant enters a login ID and a password for device registration into the mobile computing device, and the login ID and the password for registration are sent to the first processing server for verification; and
upon positive verification by the first processing server, the mobile computing device is registered with the first network infrastructure.

5. The system of claim 1, wherein the one or more mobile computing devices adapted to be used by lecturer or presenter performing a participant authentication process before connecting to the first network infrastructure, the participant authentication process comprising:
one of the one or more mobile computing devices adapted to be used by lecturer or presenter attempting to connect to the first network infrastructure;
the first processing server determining whether the mobile computing device has been registered for connecting to the first network infrastructure; and
if the mobile computing device has been registered, the participant authentication process further comprising:
the first processing server sending data to the mobile computing device instructing the mobile computing device to prompt the participant of the mobile computing device to authenticate to access the first network infrastructure;
if the participant of the mobile computing device has a near-field-communication (NFC)-enabled personal security access card, the participant motions the personal security access card near the mobile computing device for the mobile computing device to retrieve the participant's personal security access information from the personal security access card, the mobile computing device sending the participant's personal security access information to the first processing server for verification;
else if the participant of the mobile computing device has a computer-generated barcode for participant authentication, the computer-generated barcode is optically captured and decoded by the mobile computing device, and decoded information of the computer-generated barcode is sent to the first processing server for verification;
else if the participant of the mobile computing device does not have a NFC-enabled security access card or a computer-generated barcode for participant authentication, the participant enters a login ID and a password for participant authentication into the mobile computing device, and the login ID and the password for registration are sent to the first processing server for verification; and
upon positive verification by the first processing server, the participant is authenticated to access the first network infrastructure.

6. The system of claim 1, wherein the one or more mobile computing devices adapted to be used by students or audience performing a participant authentication process before connecting to the first network infrastructure, the participant authentication process comprising:
one of the one or more mobile computing devices adapted to be used by students or audience attempting to connect to the first network infrastructure;
the first processing server determining whether the mobile computing device has been registered for connecting to the first network infrastructure; and
if the mobile computing device has been registered, the participant authentication process further comprising:
the first processing server sending data to the mobile computing device instructing the mobile computing device to prompt the participant of the mobile computing device to authenticate to access the first network infrastructure;
if the participant of the mobile computing device has a near-field-communication (NFC)-enabled personal security access card, the participant motions the personal security access card near the mobile computing device for the mobile computing device to retrieve the participant's personal security access information from the personal security access card, the mobile computing device sending the participant's personal security access information to the first processing server for verification;
upon positive verification by the first processing server, a notice is sent to the mobile computing device adapted to be used by lecturer or presenter for approval by the lecturer or presenter;
before approval by the lecturer or presenter, the participant is allowed temporary access to the first network infrastructure;
upon approval by the lecturer or presenter, the participant is allowed full access to the first network infrastructure; and
if approval is denied by the lecturer or presenter, the participant is denied access to the first network infrastructure.

7. The system of claim 1,
wherein the one or more mobile computing devices adapted to be used by students or audience being divided into two or more sub-groups of one or more mobile computing devices adapted to be used by students or audience; and
wherein the division into two or more sub-groups being controlled by the lecturer or presenter by using the mobile computing device adapted to be used by lecturer or presenter.

8. The system of claim 7, wherein the lecturer or presenter, by using the mobile computing device adapted to be used by lecturer or presenter, facilitates group participation or competition in a lecture session on literature composition for the students or audience.

9. The system of claim 7, wherein the lecturer or presenter, by using the mobile computing device adapted to be used by lecturer or presenter, facilitates group participation or competition in a question-and-answer session for the students or audience.

10. The system of claim 7, wherein the lecturer or presenter, by using the mobile computing device adapted to be used by lecturer or presenter, facilitates a voting session for the students or audience.
